(19) United States
(12) Patent Application Publication
(10) Pub. No.: US 2012/0166269 A1
(43) Pub. Date: Jun. 28, 2012

(54) SYSTEM AND METHOD FOR VEHICLE IDENTIFICATION

(76) Inventors: Edward A. Payne, Greensboro, NC (US); Rodger K. Williams, Siler City, NC (US); Jonathan E. DeLine, Oak Ridge, NC (US)

(21) Appl. No.: 13/233,708

(22) Filed: Sep. 15, 2011

Related U.S. Application Data
(60) Provisional application No. 61/383,034, filed on Sep. 15, 2010.

(51) Int. Cl. H02J 7/00; G06Q 20/40; G06Q 30/02; G06Q 20/08

(52) U.S. Cl. 705/14.27; 320/109; 705/35; 705/39; 705/44; 705/14.49; 903/902; 180/65.21

(57) ABSTRACT

A system and method for handling communications between an alternate fuel vehicle and a recharging station where an adapter of the recharging station is configured to connect to a socket of the vehicle. The vehicle is configured to transmit a pilot tone via the socket to the adapter, where receipt of the pilot tone by the recharging station indicates an electrical connection between the vehicle and the recharging has been established. The vehicle is configured to modulate the pilot tone to include information useable by the recharging station, such as to effect payment for any energy provided by the recharging station.

### CROSS REFERENCE TO RELATED APPLICATIONS

The present application claims the benefit of U.S. patent application Ser. No. 61/383,034, filed on Sep. 15, 2010, in the name of Payne, et al. and entitled “System and Method for Vehicle Identification,” the entire disclosure of which is hereby incorporated by reference as if set forth verbatim herein and relied upon for all purposes.

### FIELD OF THE INVENTION

The present invention relates generally to recharging stations for electric and hybrid vehicles. More particularly, the present invention relates to communications between recharging stations and such vehicles.

### BACKGROUND OF THE INVENTION

There has been an increase in demand for vehicles utilizing fuel sources other than gasoline or that reduce the use of gasoline. For instance, hybrid or electric vehicles contain batteries or other energy storage components that supply power to the portions of the vehicles that require it rather than using combustible fuels. While the batteries are rechargeable, vehicles comprising them are generally only capable of traveling shorter distances in comparison to their gasoline-based counterparts before it becomes necessary to recharge the batteries. Accordingly, there has arisen a need for recharging facilities or stations that allow such vehicles to be recharged at locations other than the users' residences.

At a recharging station, the user electrically couples the vehicle to a recharging dispenser. This is usually performed by connecting a cable or series of cables from the dispenser to a socket of the vehicle. Often, the cables from the dispenser terminate in an adapter configured to engage with the vehicle's socket. The vehicle transmits a signal or pilot tone via the socket, which is received by the dispenser once the adapter is connected. Receipt of the signal by the dispenser indicates that a secure connection exists between the vehicle and the dispenser. The dispenser must receive the signal indicating the existence of the secure connection before it will supply electricity over the cables to the vehicle's socket at levels that would be hazardous if the user came into contact with the disconnected cables.

Often, the vehicle and/or cables will include a locking mechanism. When the dispenser receives the pilot tone from the vehicle indicating the presence of a secure connection, the dispenser or the vehicle will engage the locking mechanism so that the cables cannot be disconnected from the vehicle's socket prior to termination or completion of the recharging sequence. This prevents the cables from detaching from the vehicle while dangerous levels of electricity are being transferred via the cables.

### SUMMARY OF THE INVENTION

The present invention recognizes and addresses the foregoing considerations, and others, of prior art construction and methods.

In this regard, one aspect of the invention is directed to a recharging station for alternate fuel vehicles (“AFVs”), such as electric or hybrid vehicles. Recharging stations are configured to provide energy to AFVs in a manner somewhat similar to the manner in which fueling stations are configured to provide fuel to vehicles powered by combustible fuels. Information and examples of retail fueling environments, fuel dispensers, and user interfaces for the dispensers are provided in U.S. Pat. Nos. 6,453,204 (entitled “Fuel Dispensing System”), 5,956,259 (entitled “Intelligent Fueling”), 5,734,851 (entitled “Multimedia Video/Graphics in Fuel Dispensers”), 6,052,629 (entitled “Internet Capable Browser Dispenser Architecture”), 5,689,071 (entitled “Wide Range, High Accuracy Flow Meter”), 6,935,191 (entitled “Fuel Dispenser Fuel Flow Meter Device, System and Method”), and 7,289,877 (entitled “Fuel Dispensing System for Cash Customers”) and U.S. patent application Ser. Nos. 12/191,081 (entitled “Fuel Dispenser” and filed on Aug. 13, 2008), 12/689,983 (entitled “Payment Processing System for Use in a Retail Environment Having Segmented Architecture” and filed on Jan. 19, 2010), and 12/695,692 (entitled “Virtual PIN Pad for Fuel Payment Systems” and filed on Jan. 28, 2010), the entire disclosure of each of which is hereby incorporated by reference as if set forth verbatim herein for all purposes.

Another aspect of the present invention provides a recharging station configured to recharge a battery of an alternate fuel vehicle. The recharging station comprises a power supply for providing energy to the vehicle and an adapter in electric communication with the power supply. The adapter is configured to connect to the vehicle and to receive a signal indicating that a connection to the vehicle has been established. The recharging station also comprises circuitry operatively connected to the adapter and configured to retrieve data from a modulated portion of the signal provided by the vehicle.

According to another aspect, the present invention provides an alternate fuel vehicle comprising a battery configured to provide power to the vehicle and a socket in electrical communication with the battery. The socket is configured to connect to a component of a recharging station in order to receive energy from the recharging station and direct the energy to the battery. The vehicle also comprises circuitry in electrical communication with the socket and configured to transmit a signal useable to indicate when a connection has been established between the socket and the component. The circuitry is also configured to modulate the signal to include information.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a partially schematic, side elevation view of a recharging station in accordance with an embodiment of the present invention;

FIG. 2 is a partially schematic representation of a connection of a recharging dispenser to a wide area network in accordance with an embodiment of the present invention; and

FIG. 3 is a flowchart illustrating an exemplary process for recharging a vehicle using the recharging station of FIG. 1.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

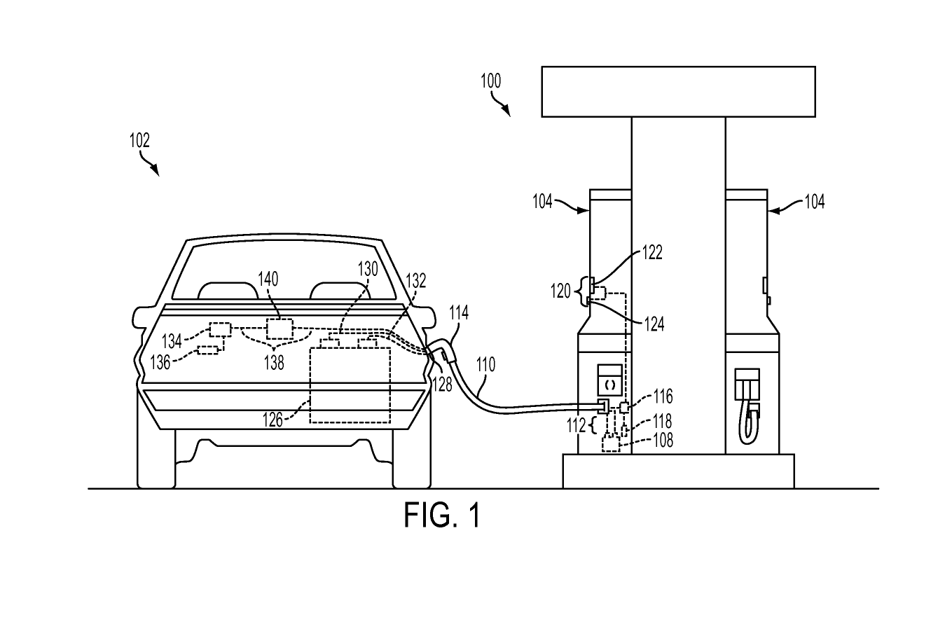

FIG. 1 illustrates a recharging station 100 adapted to supply electricity in order to recharge hybrid and/or electric vehicles, such as vehicle 102. Recharging station 100 comprises at least one recharging dispenser 104. In one embodiment, recharging station 100 is a standalone device, but may be part of a larger recharging facility in another embodiment. As should be appreciated by those skilled in the art, if a facility is associated with recharging station 100, the facility may also include a central building and additional recharging stations similar to station 100, each of which may include one or more recharging dispensers similar to dispenser 104.

Recharging dispenser 104 comprises a voltage source 108 in electrical communication with a dispensing cable 110 via voltage circuitry 112. Cable 110 terminates in an adapter 114 configured to interact with a corresponding socket 128 of vehicle 102, as described in more detail below. Adapter 114 comprises a locking mechanism that is configured to secure to socket 128 of vehicle 102 in order to create an electric connection between dispenser 104 and the vehicle. An example of such an adapter is described in the Society of Automotive Engineers (“SAE”) North American standard for electrical connectors for electric vehicles, which is identified as SAE J1772.

Circuitry, including a processing device 116 and associated memory 118, is operatively connected to one or more of the components of dispenser 104 described above in order to control and manage the distribution of electricity as explained in more detail below. Recharging dispenser 104 may comprise additional components, such as a user interface 120. User interface 120 may include a display, such as a touchscreen 122 and a card reader 124. It should be understood that user interface 120 may comprise additional components, including a PIN pad or keypad, radio frequency identification (“RFID”) tag reader for reading RFID tags, a contactless card reader or smartcard reader for reading contactless cards or smartcards, respectively, a cash acceptor for facilitating a cash transaction, and/or a printer for printing a receipt if desired. In one embodiment, processing device 116 is operatively connected to the components of user interface 120, including touchscreen 122 and card reader 124.

In an embodiment where the facility associated with recharging station 100 includes a central building, it may take the form of a convenience store, as is well-known in the art. The central building may include one or more computing devices, such as a point-of-sale device (“POS”) or a manager's workstation. Should either a POS or manager's workstation be present, it should be understood that each comprises its own processing device and memory operatively connected to the processing device.

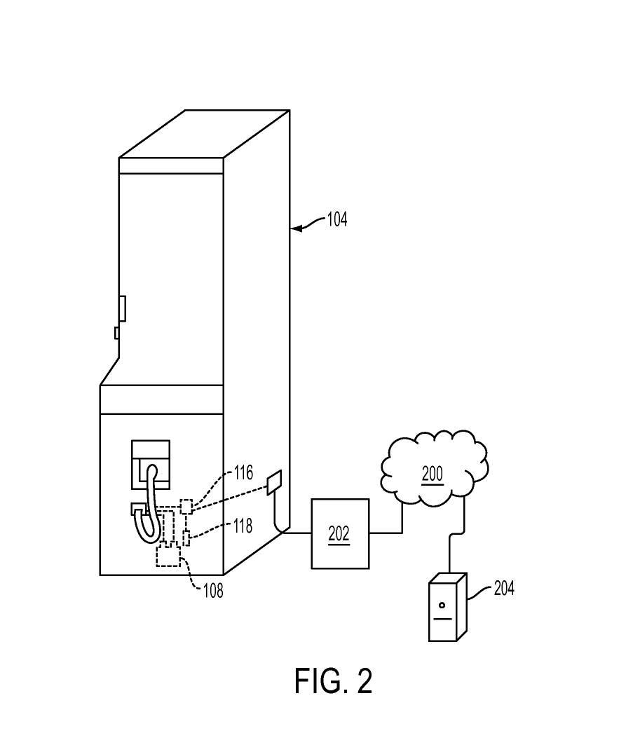

Referring additionally to FIG. 2, recharging dispenser 104 is operatively connected to a wide area network (“WAN”) 200, such as the Internet, either directly or via a local area network (“LAN”) 202. Resources remote to the facility associated with recharging dispenser 104, such as server 204, are also operatively connected to WAN 200. It should be understood that LAN 202 may include various components that facilitate the transmission of data from recharging dispenser 104 to WAN 200, such as distribution boxes, routers, and gateways, for example. The connection between recharging dispenser 104 may also be accomplished via the POS described above. It should be understood that the connection between dispenser 104 and WAN 200 may be accomplished by any suitable technologies, including wired and wireless connections, or any combination thereof. Examples of suitable configurations, for instance, are set forth in application Ser. No. 12/689,983 referenced above. It should be understood that other configurations and arrangements may be employed without departing from the scope of the present invention.

In certain embodiments, for example, a central building may be unnecessary, such as when recharging station 100 or dispenser 104 operates in an unattended scenario. In such an embodiment, processing device 116 is operatively connected to WAN 200 either directly or via one or more secure devices, examples of which are set forth in application Ser. No. 12/689,983.

Referring again to FIG. 1, vehicle 102 comprises a battery 126 (or a bank of batteries connected together) and socket 128 in electric communication with the battery via positive and negative connection paths 130 and 132. Battery 126 is also in electric communication with other components of vehicle 102 in order to provide power to those components, as should be understood in the art. Socket 128 may include a locking device configured to secure adapter 114 to the socket as described in more detail below. Alternatively, socket 128 includes a mechanism that interacts with the locking mechanism of adapter 114 in order to create a secure connection between the two. Vehicle 102 comprises additional circuitry, including a processing device 134 and memory 136 operatively connected to the processing device. Processing device 134 is in electric communication with socket 128, which may be accomplished via a communication path 138 and one or more electric components 140. Processing device 134 may also be operatively connected to battery 126 in order to monitor certain aspects of the battery, such as its capacity. In one embodiment, processing device 134 is a controller or processor conventionally included within vehicle 102. Alternatively, processing device 134 may be another, separate processing device configured to handle communication with dispenser 104, as described in more detail below. Electric components 140 comprise transmit-and-receive circuitry configured to handle transmission and modulation of a signal in the manner described below and as should be understood by those skilled in the art.

Each of processing devices 116 and 134 may be a processor, microprocessor, controller, microcontroller, or other appropriate circuitry. For example, multiple electronic devices configured to operate together within recharging dispenser 104 or vehicle 102, respectively, may be considered a “processing device.” Each of memories 118 and 136 may be any type of memory or computer-readable medium as long as it is capable of being accessed by processing devices 116 and 134, respectively, including random access memory (“RAM”), read-only memory (“ROM”), erasable programmable ROM (“EPROM”) or electrically EPROM (“EEPROM”), CD-ROM, DVD, or other optical disk storage, solid state drive (“SSD”), magnetic disk storage, including floppy or hard drives, any type of non-volatile memories, such as secure digital (“SD”), flash memory, memory stick, or any other medium that may be used to carry or store computer program code in the form of computer-executable programs, instructions, or data. Processing device 116 or 134 may also include a portion of memory accessible only to the processing device, commonly referred to as “cache.” Thus, memory 118 and 136 may be part of the respective processing device, may be separate therefrom, or may be split between the respective processing device and a separate memory device.

Each of memories 118 and 136 comprises computer-executable program code or instructions that when executed by the respective processing device perform one or more of the processes described in more detail below. Memory 118 or 136 may also comprise one or more data structures for storing information. The computer-executable program code or instructions in this scenario, as should be known to those skilled in the art, usually include one or more application programs, other program modules, program data, firmware, and/or an operating system.

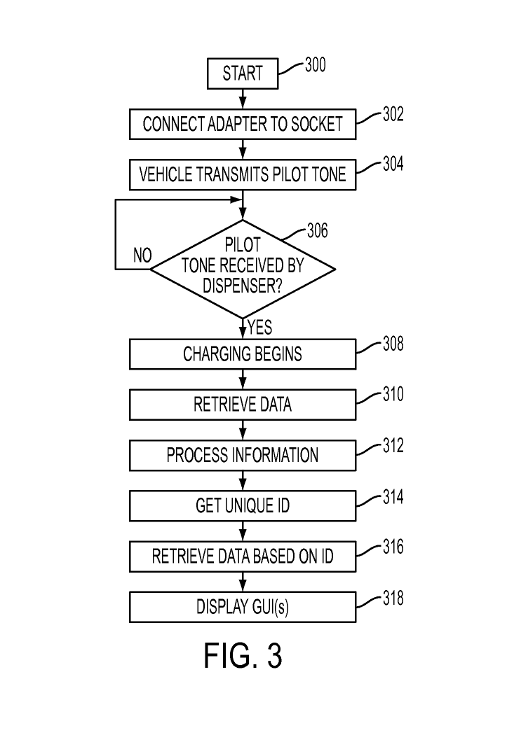

FIG. 3 illustrates an exemplary process of using recharging station 100 in order to recharge a battery of an alternate fuel vehicle. Referring to FIGS. 1, 2, and 3, a user positions vehicle 102 adjacent to dispenser 104 at step 300. In a preferred embodiment, touchscreen 122 is configured to display a graphical user interface (“GUI”) comprising instructions to the user. For instance, touchscreen 122 may instruct the user to connect adapter 114 to the user's vehicle. In one embodiment, processing device 116 retrieves data representative of the GUI from memory 118 and transmits the data to touchscreen 122 to be displayed. The instructions may include a detailed description of the manner by which the adapter 114 should be connected to socket 128, such as an animation or short video.

At step 302, the user retrieves cable 110 from dispenser 104 and connects adapter 114 to socket 128 of vehicle 102. The locking mechanisms of adapter 114 and/or socket 128 interact to create a secure connection. The connection between adapter 114 and socket 128 is such that prevents the two from accidentally becoming disconnected. That is, adapter 114 and/or socket 128 include mechanisms that require the two to be purposefully disconnected. Additional information regarding such a connection can be found in the SAE J1772 specification referenced above.

At step 304, processing device 134 instructs vehicle 102 to transmit a pilot tone via communication path 138 and socket 128. In one embodiment, vehicle 102 begins transmitting the tone when processing device 134 receives an indication that an event has occurred, such as when the ignition switch is turned to the “off” position or a door configured to cover socket 128 is opened. Alternatively, vehicle 102 may continuously transmit the pilot tone. In the presently-described embodiment, the pilot tone is a one kilohertz (1 KHz) signal. Processing device 134 retrieves data stored in memory 136 and instructs electric components 140 to modulate the pilot tone to include the data. Examples of the contents of the data are provided and described in more detail below.

If adapter 114 is securely fastened to socket 128 in the manner described above, the adapter receives the pilot tone at step 306. In one embodiment, receipt of the pilot tone by adapter 114 causes the adapter's locking mechanism to engage or otherwise lock, thereby securing adapter 114 to socket 128. Regardless, adapter 114 may not be disconnected from socket 128 at this point prior to termination or completion of the recharging process. The pilot tone is transmitted from adapter 114 to processing device 116 via cable 110.

At step 306, processing device 116 continuously checks to determine whether recharging dispenser 104 has received the pilot tone from vehicle 102. Receipt of the pilot tone by processing device 116 at step 306 indicates adapter 114 and socket 128 are securely connected and process flow proceeds to step 308. As a result, processing device 116 authorizes the flow of energy from power source 108 to battery 126, so that recharging of the battery begins, in one embodiment. If processing device 116 does not receive the pilot tone, process flow returns to step 306, where touchscreen 122 continues to display instructions to the user to connect adapter 114 to socket 128. In another embodiment, dispenser 104 may require payment prior to authorizing the flow of energy from power source 108, as should be understood in the art.

At step 310, processing device 116 analyzes the modulation of the pilot tone in order to retrieve the data included in the pilot tone by processing device 134. In one embodiment, this is accomplished via transmit-and-receive circuitry operatively connected to the processing device and configured to handle receipt and demodulation of a signal as should be understood by those skilled in the art. At step 312, recharging dispenser 104 extracts and processes the information contained in the retrieved data in a manner dependent upon the information included in the data, as explained in more detail below.

In the presently-described embodiment, for example, memory 136 comprises a code unique to vehicle 102 and/or the vehicle's operator or owner. The code may be the vehicle's identification number (or “VIN”) or may be any other code that uniquely identifies vehicle 102, its operator or owner, or both. Instead of, or in addition to the code, memory 136 may contain additional information related to the user, such as the user's account information for a loyalty program associated with recharging station 100.

In the manner described above, processing device 134 locates and retrieves the information stored in memory 136. Electric components 140 modulate the pilot tone so that the retrieved information is embedded in the modulated signal. Upon receipt of the modulated signal, processing device 116 retrieves the information embedded in the modulated signal at step 314. In this embodiment, processing device 116 is able to identify the user's loyalty program account from the data included in the modulated portion of the pilot tone/signal and use the data in a manner understood by those skilled in the art.

At step 316, for instance, processing device 116 requests information corresponding to the unique code from the POS, server 204, or any other device operatively connected to LAN 202 or WAN 200. For example, processing device 116 may query (1) the POS to determine how many times the vehicle has used recharging station 100 in a given timeframe, (2) another device to determine whether there are products or services being offered by the operator of recharging station 100 or its affiliates that correspond to the type of vehicle 102, and/or (3) server 204 to determine the recharging capacity or other aspects specific to the type of vehicle.

In one embodiment, dispenser 104 uses the information provided by the POS, external resources, such as server 204, and/or any other applicable device or resource to present relevant information to the user at step 318. For example, dispenser 104 may instruct display 122 to present GUIs including advertisements for products designed to be used with the type of vehicle that corresponds to the VIN, such as specialized floor mats. At this point, the user can further interact with dispenser 104, and specifically user interface 120, to purchase any of the goods or services offered, as should be appreciated by those skilled in the art.

It should be understood that any data may be modulated onto the pilot tone by processing device 134 to be extracted and analyzed by processing device 116, including payment information. In another embodiment, for instance, the information contained in the modulated signal comprises payment information associated with the owner of vehicle 102. For example, memory 136 includes information corresponding to one or more of the owner's credit or debit cards. Processing device 134 formats the relevant information and modulates the pilot signal to include the information. Processing device 116 retrieves the signal and extracts the information contained therein in a manner similar to that described above. Upon completion of the recharging process, processing device 116 uses the information to effect a payment transaction for the energy provided by dispenser 104 in one embodiment. For instance, processing device 116 transmits the information to the financial institution responsible for the user's account. This may be accomplished by transmitting the data to a server maintained by the financial institution, such as server 204 in this example, via LAN 202 and WAN 200. Server 204 processes the information, which may include debiting the user's account as should be understood in the art.

In another embodiment, the user provides payment information to dispenser 104 via user interface 120 in any manner known to those in the art or as described in application Ser. No. 12/695,692 referenced above.

In yet another embodiment where the pilot tone initially transmitted by vehicle 102 is modulated to include payment information, processing device 116 uses the payment information to preauthorize the recharging transaction, as should be appreciated by those skilled in the art. In this scenario, processing device 116 transmits the payment information to server 204 in order to preauthorize the recharging process prior to allowing dispenser 104 to provide energy to vehicle 102. For instance, once the locking mechanism of adapter 114 engages socket 128, processing device 116 receives the pilot tone, extracts the payment information, and transmits it to server 204 in the manner described above. Depending on the response from server 204, as should be understood in the art, processing device 116 authorizes dispenser 104 to provide energy to vehicle 102. Upon completion of the recharging process, processing device 116 effects payment for the energy provided by dispenser 104 in a manner similar to that described above.

It should be understood that other suitable sequences of payment processing understood by those skilled in the art may be used without departing from the scope of the present invention. In another embodiment, for example, the user's payment account information may be modulated into the pilot tone/signal. Upon receipt of the information by processing device 116, the processing device may instruct user interface 120 to request additional payment information from the user, such as a personal identification number or “PIN.” It should further be understood that the payment transactions described above may be carried out by any suitable arrangement of devices, such as those described in application Ser. No. 12/689,983 referenced above. It should also be understood that the user may provide payment information for the recharging process in any other manner known to those in the art, such as by using card reader 124 to swipe a payment card bearing a magnetic strip.

In a further embodiment, the information contained in the modulated signal comprises additional information corresponding to the user. This information may include the user's residential information, his or her preferences regarding the recharging process, and/or whether the user is a member of any other loyalty programs for organizations other than that associated with recharging station 100. Based on the information contained in the modulated pilot tone, processing device 116 requests information from the POS or resources external to recharging station 100. The requested information may include, for instance, marketing or promotional material, including video or audio, directed to the user. For example, if the information contained in the modulated signal indicates that the user is a member of a loyalty program for a specific hotel chain, processing device 116 requests information regarding nearby hotels that are part of the hotel chain from a resource associated with the chain, such as server 204 in this example. Upon receipt of this information, processing device 116 may instruct display 122 to present the promotional material or a map to any nearby hotels that are members of the corresponding chain. Processing device 116 may instruct a printer to print directions to one of the hotels or a coupon to be presented to a nearby hotel, store, or restaurant, if dispenser 104 includes a printer.

As noted above, processing device 134 may retrieve additional information from memory 136 throughout the recharging process and modulate the pilot tone to include the additional information. For instance, the modulated pilot tone may initially comprise payment information so that recharging station 100 may automatically preauthorize the transaction before proceeding with the recharging process. After the process has begun, the modulated pilot tone may be altered to comprise information associated with the user or the type of vehicle so that station 100 may direct marketing material of interest to the user, in a manner similar to that described above.

In the embodiment in which the modulated pilot tone comprises account or other private information, processing device 134 encodes and/or encrypts the information before modulating the signal to include the encrypted information. After the relevant data is extracted from the modulated pilot tone received by dispenser 104, processing device 116 decodes or decrypts the information to retrieve the sensitive or confidential information. It should be understood that any suitable encoding or encryption method known to those skilled in the art may be employed without departing from the scope of the present invention.

In another embodiment, dispenser 104 is adapted to transmit an outgoing signal to vehicle 102 via cable 110. In this embodiment, vehicle 102 transmits the pilot tone, which may be modulated to include information from memory 136 as set forth above. After dispenser 104 receives the signal, engages the locking mechanism, retrieves the information contained in the modulated portion of the signal, and begins the recharging process, vehicle 102 ceases transmitting the pilot tone. At this point, dispenser 104 transmits a signal via cable 110 to vehicle 102 containing information relevant to the user and/or the type of vehicle. The information may be included in a modulated portion of the signal. In an embodiment where vehicle 102 comprises a display accessible to the user, processing device 134, retrieves, analyzes, and presents the information via the vehicle's display. In this manner, marketing or other relevant information may be provided to the user or other occupants of the vehicle from within the vehicle. Also in this manner, vehicle 102 and dispenser 104 may request and provide additional information to one another. In an embodiment where the vehicle's display comprises a touchscreen, for example, the user may request the location of and directions to a nearby restaurant from within vehicle 102 using the touchscreen. Dispenser 104 may provide the location and directions of a recommended restaurant in the vicinity, as well as a coupon or code to be used at the restaurant for a discount. The vehicle's occupants may further interact with dispenser 104 in a similar manner.

It should be understood from the above description that recharging station and, particularly dispenser 104, may take forms other than one similar to a conventional fuel dispenser. For instance, the functionality of dispenser 104 described above may be included within a parking meter or a charging station in a parking lot or garage. As a result, the user may recharge vehicle 102 in an unattended manner while performing other tasks, such as purchasing groceries. Additionally, the information provided by vehicle 102 may be used to provide payment for any fees incurred by virtue of parking the vehicle at the meter. That is, the payment information may be used to effect payment for both the recharging and parking fees. Alternatively, the information provided by vehicle 102 may be used to provide a prepayment for any fees incurred as a result of the parking or the recharging process.

In an embodiment where recharging station 100 is configured as a parking meter or included within a parking garage or lot, the facility associated with the recharging station may include a user interface operatively connected to the station. For instance, the user interface may be incorporated into an unattended payment kiosk located at the entrance and/or exit of a parking garage, such as those connected to an airport, and is operatively connected to each dispenser. Alternatively, each recharging station 100 may be associated with a user interface. Regardless, it should be understood that a user may provide information via the user interface in addition to or instead of that provided by vehicle 102. For example, if dispenser 104 does not recognize the identification, or “id,” provided by vehicle 102 or should the user desire to use payment account information other than that provided by the vehicle, the user interface may be used to provide the appropriate information.

It should also be understood that the connection between vehicle 102 and dispenser 104 via socket 128 and adapter 114, respectively, may be used for other purposes. For instance, vehicle 102 may transmit data to dispenser 104 sufficient to create a connection between the two via other forms of communication. That is, for example, vehicle 102 and dispenser 104 may each be equipped with other means of communication, such as a wireless fidelity (“Wi-Fi”) or Bluetooth adapter. In such an embodiment, vehicle 102 may transmit a secure code, PIN, service set identifier (“SSID”) and password combination, or any other necessary information to dispenser 104 in order to allow the vehicle's wireless adapter to connect to and communicate with that of the dispenser. Vehicle 102 and dispenser 104 may then communicate by transmitting data or information in any manner understood by those skilled in the art.

While one or more preferred embodiments of the invention have been described above, it should be understood that any and all equivalent realizations of the present invention are included within the scope and spirit thereof. The embodiments depicted are presented by way of example only and are not intended as limitations upon the present invention. Thus, it should be understood by those of ordinary skill in this art that the present invention is not limited to these embodiments since modifications can be made. Therefore, it is contemplated that any and all such embodiments are included in the present invention as may fall within the scope and spirit thereof.

What is claimed is:

1. A recharging station configured to recharge a battery of an alternate fuel vehicle comprising:
a power supply for providing energy to the vehicle;
an adapter in electric communication with the power supply and configured to connect to the vehicle and to receive a signal indicating a connection to the vehicle has been made; and
circuitry operatively connected to the adapter and configured to retrieve data from a modulated portion of the signal provided by the vehicle.

2. The recharging station of claim 1 further comprising a display operatively connected to the circuitry, wherein the circuitry is configured to provide information to the display to be presented.

3. The recharging station of claim 2 wherein the information provided by the circuit is based at least in part on data extracted from the signal provided by the vehicle.

4. The recharging station of claim 2 wherein the circuitry is configured to receive the information to be presented from a resource external to the recharging station.

5. The recharging station of claim 1 wherein the data extracted from the signal provided by the vehicle comprises payment information.

6. The recharging station of claim 5 wherein the circuitry is configured to transmit the payment information to a financial institution associated with the payment information in order to effect payment for any energy provided by the recharging station.

7. The recharging station of claim 6 further comprising an input device configured to receive a personal identification number (“PIN”), wherein the circuitry is configured to transmit the PIN to the financial institution.

8. The recharging station of claim 7 wherein the input device is a touchscreen.

9. The recharging station of claim 8 wherein the input device is a keypad.

10. The recharging station of claim 1 comprising a user interface including an input device for receiving payment information, wherein the circuitry is configured to transmit the payment information to a financial institution associated with the payment information.

11. The recharging station of claim 10 wherein the input device is a card reader configured to receive the payment information from a magnetic strip card.

12. An alternate fuel vehicle comprising:
a battery configured to provide power to the vehicle;
a socket in electrical communication with the battery and configured to connect to a component of a recharging station in order to receive energy from the recharging station for charging the battery; and
circuitry in electrical communication with the socket and configured to transmit a signal useable to indicate when a connection has been established between the socket and the component and configured to modulate the signal to include information.

13. The vehicle of claim 12 wherein the information comprises a code unique to the vehicle.

14. The vehicle of claim 13 wherein the code is a vehicle identification number of the vehicle.

15. The vehicle of claim 12 wherein the information comprises payment information unique to a user associated with the vehicle and useable to effect payment for any energy provided by the recharging station.

16. The vehicle of claim 12 wherein the information comprises loyalty program account information unique to a user associated with the vehicle.

17. The vehicle of claim 12 wherein the information comprises loyalty program account information unique to a user associated with the vehicle and corresponds to one of the group comprising a hotel chain, an airline, and a restaurant chain.

18. The vehicle of claim 12 wherein the information is used to present marketing material to a user associated with the vehicle.

19. The vehicle of claim 12 wherein the circuitry is configured to modulate the signal to include different information at least one predetermined interval of time during a recharging process.

20. The vehicle of claim 12 wherein the circuitry is in electric communication with the battery in order to measure a level of energy of the battery and is configured to modulate the signal to include different information based on the level of energy.
